(19) United States
(12) Patent Application Publication
(10) Pub. No.: US 2011/0153298 A1
(43) Pub. Date: Jun. 23, 2011

(54) VEHICLE ROLLOVER SIMULATION

(76) Inventors: Douglas J. Stein, Leonard, MI (US); Charles Sherwin, Mayville, MI (US)

(21) Appl. No.: 12/646,690

(22) Filed: Dec. 23, 2009

(51) Int. Cl. G06G 7/70

(52) U.S. Cl. 703/8

(57) ABSTRACT

A system simulates conditions in a vehicle enclosure during a tripped rollover by manipulating an indestructible test article modeling the vehicle. A movable test platform upholding the test article in an unsecured manner is driven by an accurately repeatably programmable propulsion source in a horizontal test-initiation direction. The initiation of motion causes the test platform to tilt downwardly in a rollover direction opposed to the test-initiation direction. A height-adjustable trip block on the test platform is brought to bear against a lower portion of the test article, imparting to the test article rotational motion about a horizontal tipping axis oriented normal to each of the test-initiation direction and the rollover direction. The rotational motion inclines the test article upwardly from the test platform in the rollover direction and ejects the test article from the test platform for capture on an accompanying landing platform.

### BACKGROUND OF THE INVENTION

### Field of the Invention

The present invention relates to the study of the dynamic conditions that arise in the passenger enclosure of a motor vehicle during an accident. More particularly, the present invention pertains to the simulation of such conditions during a rollover.

### Background

Rollover-related crashes represent a mere three percent (3%) of all passenger vehicle crashes in the United States. Yet, incidents of vehicular rollover account for one third of the fatalities that occur due to vehicular operation. Thus, about 10,000 individuals die annually in rollover crashes.

The vast majority of vehicular rollover crashes are of a type that is referred to as a “tripped” rollover. In a tripped vehicular rollover, lateral forces acting on tires of a moving vehicle destabilize the secure footing of the vehicle upon its full plurality of tires and tip the vehicle sideways in a rollover direction. Most commonly, these lateral forces develop when the tires of the moving vehicle encounter a crib or other obstacle, or when the tires of that vehicle commence to dig into a yielding support surface, such as grading or soil at the side of a thoroughfare.

At slower rollover speeds, a vehicle overturns in the rollover direction onto the adjacent side thereof. At greater rollover speeds, the vehicle continues in its rotational motion coming to rest onto its roof. At extreme rollover speeds, the vehicle may momentarily be in freefall flight before impacting the ground or pavement high on the adjacent side of the vehicle, or even directly upon the roof thereof.

The dynamic conditions created in a passenger enclosure during a tripped vehicle rollover are extreme and complex. The safety of passengers subjected to such dynamic conditions is being enhanced through the development of advanced restraint systems that are installed within the passenger compartment.

The efficient refinement of such advanced restraint systems is highly dependent on the corresponding development of testing methods that can reliably and inexpensively determine the effects on vehicular occupants of tuning changes in such restraint systems. Full vehicle rollover crash testing with crash test dummies has been employed for this purpose in the past. Yet, rollover crash tests require large laboratory spaces. A single test run of this type requires a substantial amount of set up time, and a fresh vehicle model with new crash test dummies may be necessary for each individual run. Full rollover crash testing is, therefore, very costly.

Unfortunately, full vehicle rollover crash testing produces data of unacceptable repeatability, because from one test run to another, the conditions of a trip rollover are difficult to replicate accurately. Consequently, vehicular responses, restraint system behaviors, and occupant kinematics cannot be correlated closely to initial conditions or to each other.

### BRIEF SUMMARY OF THE INVENTION

According to teachings of the present invention, a system for simulating conditions in a vehicle enclosure during a tripped rollover manipulates a test article modeling the vehicle and having a floor upon which to rest, a center of gravity above that floor, and a test axis that corresponds to the longitudinal axis of the vehicle being modeled.

A movable test platform having a horizontal carrying surface capable of upholding the floor of the test article in a manner unsecured to the test platform is operable interconnected with a propulsion source that drives the test platform with the test article upheld thereon in a substantially horizontal test-initiation direction normal to the test axis of the test article. The driving pattern imposed on the test platform by the propulsion source is accurately repeatable programmable, for example, through the use of a servo-controlled thruster. The interaction between the driven test platform and the test article imparts to the test article rotational motion about a tipping axis that is oriented parallel to the test axis. That rotational motion inclines the floor of the test article upwardly from the carrying surface of the test platform in a rollover direction that is opposed to the test-initiation direction, and the test article is ejected from the test platform in the rollover direction.

According to another aspect of the present invention, a system of the type described also includes a trip block upstanding from the carrying surface of the test platform at a position located in the rollover direction from the test article upheld thereon. Then, motion of the test platform in the test-initiation direction causes the trip block to bear against the test article between the floor and the center of gravity thereof. The height of the trip block above the carrying surface of the test platform is selectively adjustable to simulate various vehicle tripping circumstances. An embodiment of the trip block is resiliently compressible in the rollover direction against the test article, and the amount of the force borne against the test article by the trip block corresponds to the degree of the compression of the trip block. Such a trip block includes an upright secured to the carrying surface of the test platform at a position located in the rollover direction from the test article upheld thereon, a test article engagement shoe capable of abutting the test article between the floor and the center of gravity thereof, and a substantially horizontally disposed resilient buffer urging the engagement shoe away from the upright in the test-initiation direction.

The horizontal orientation of the carrying surface of the test platform with the test article upheld thereon is able to vary in response to the initiation of a driving pattern imposed on the test platform by the propulsion source. More specifically, the initiation of a driving pattern causes the carrying surface of the test platform with the test article upheld thereon to tilt downwardly in the rollover direction.

Also according to teachings of the present invention, a system for simulating conditions in the enclosure of a vehicle during a tripped rollover includes a carriage rollingly moveable on a rail in the test-initiation direction from a stationary position and a test platform with a horizontal carrying surface borne on the carriage. The test platform is dynamically mounted on the carriage, enabling the horizontal orientation of the carrying surface of the test platform to vary in response to the initiation of movement by the carriage. A rigid testing shell houses a model of the enclosure of the vehicle and has a floor, a center of gravity above the floor, and a test axis corresponding to the longitudinal axis of the vehicle being modeled. The testing shell is upheld by the floor thereof with test axis of the testing shell oriented normal to the test-initiation direction on the carrying surface of the test platform in a manner that is unsecured to the test platform. The system is set into motion by an accurately repeatable programmable servo-controlled thruster that operably interacts with the carriage to drive the carriage, the test platform, and a test shell in the test-initiation direction.

A trip block is upstanding from the carrying surface of the test platform at a position located in the rollover direction from the testing shell upheld thereon. Motion of the test platform in the test-initiation direction causes the trip block to bear against the testing shell between the floor and the center of gravity thereof. The height of the trip block above the carrying surface of the test platform is selectively adjustable. The trip block is resiliently compressible in the rollover direction against the test article with the amount of the force borne against the test article by the trip block corresponding to the degree of the compression of the trip block.

In other aspects of the present invention, on a carriage of the type described above are a mounting for the test platform and a landing platform. The landing platform is positioned in the rollover direction from the test platform and configured to receive the testing shell when motion of the carriage in the test-initiation direction ejects the testing shell from the test platform. The mounting for the test platform includes a pivotable support for the test platform at a position on the test platform located in the test-initiation direction relative to the testing shell, and a resilient support for the test platform at a position on the test platform located in the rollover direction relative to the testing shell. A tether flexibly securing the testing shell on the test platform to the landing platform may take the form of flexible webbing, cords, or a sequence of pivotably end-to-end secured rigid links connected between the landing platform and the testing shell on the test platform.

According to yet another aspect of the present invention, a method is provided for simulating conditions in a vehicle enclosure during a tipped rollover. The method commences by constructing a test article modeling the vehicle. The test article has a floor, a center of gravity above the floor, and a test axis corresponding to the longitudinal axis of the vehicle being modeled. The test article is then upheld in an unsecured manner on a mobile test platform configured for motion in a substantially horizontal test-initiation direction normal to the test axis of the test article thereon. Using motion of the test platform in the test-initiation direction, the test article is ejected from the test platform in a rollover direction opposed to the test-initiation direction. A mobile landing platform is positioned in proximity to the test platform in the rollover direction therefrom and moved with the test platform in the test-initiation direction to thereby receive the test article ejected from the test platform.

The ejection of the test article from the test platform involves moving the test platform in the test-initiation direction, tilting the test platform with the test article thereon downwardly in the rollover direction, and catching the test article between the floor and the center of gravity thereof against an upstanding trip block on the test platform.

### BRIEF DESCRIPTION OF THE SEVERAL VIEWS OF THE DRAWINGS

In order that the manner in which the above-recited and other features and advantages of the present invention are obtained will be readily understood, a more particular description of the present invention briefly described above will be rendered by reference to specific embodiments thereof which are illustrated in the appended drawings. Understanding that these drawings depict only typical embodiments of the present invention and are not therefore to be considered to be limiting of scope thereof, the present invention will be described and explained with additional specificity and detail through the use of the accompanying drawings in which:

FIGS. 1A-1F form a sequence of perspective diagrams depicting the operation of a first embodiment of a vehicle rollover simulation system incorporating teachings of the present invention;

FIGS. 2A-2C form a sequence of diagrams depicting the operation of a second embodiment of a vehicle rollover simulation system incorporating teachings of the present invention;

FIG. 3 is an elevation view of an embodiment of selected elements of the vehicle rollover simulation system of FIGS. 2A-2C;

FIG. 4 is an elevation view of another embodiment of a vehicle rollover simulation system incorporating teachings of the present invention; and

FIG. 5 is a flow chart of an embodiment of a method by which to simulate conditions in a vehicle enclosure during a rollover according to teachings of the present invention

### DETAILED DESCRIPTION OF THE INVENTION

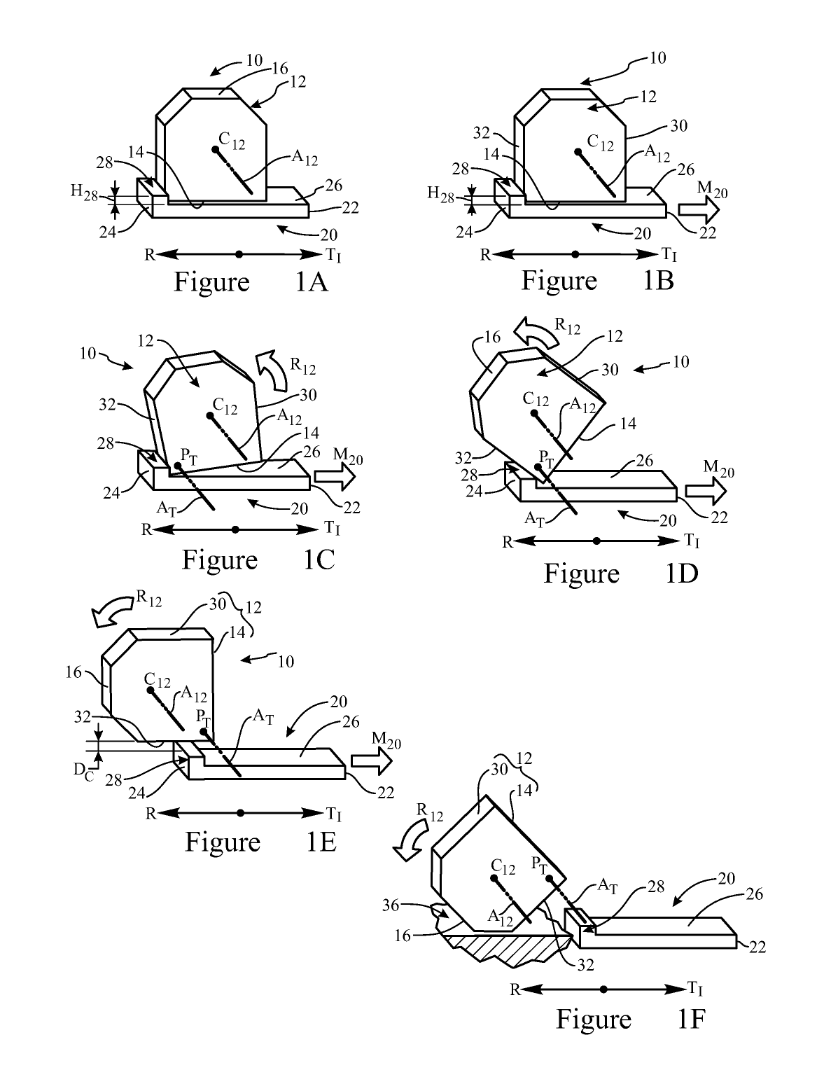

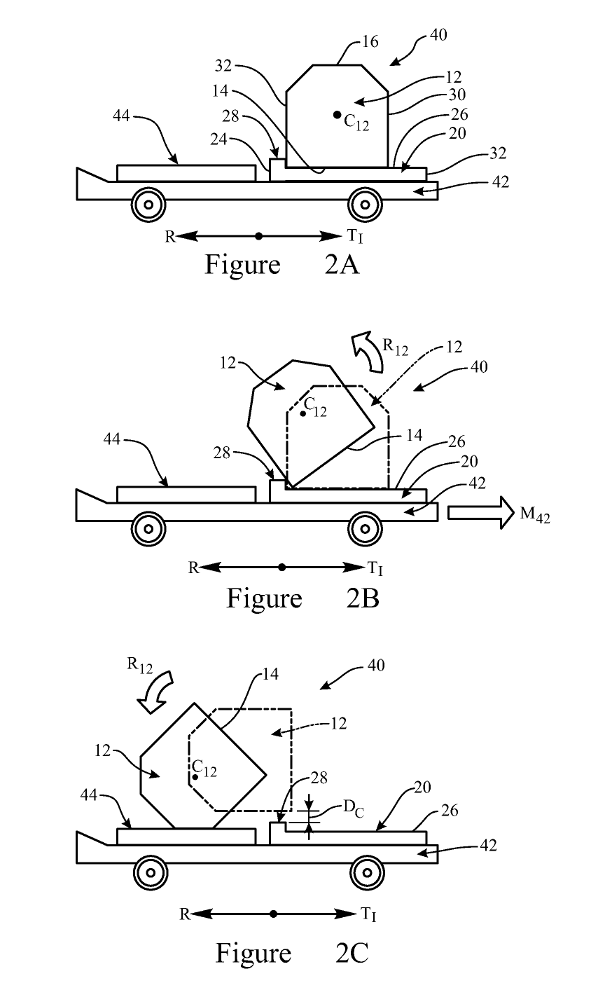

Embodiments of the present invention will be best understood by reference to the drawings, wherein like parts are designated by like numerals throughout. It should be understood that the components and procedures of the present invention, as generally described and illustrated in the accompanying figures, can be arranged and designed in a wide variety of different configurations. Thus, the following more detailed description of embodiments of the present invention, as represented in FIGS. 1-5, is not limitative of the scope of the present invention, as claimed, but is merely representative of selected exemplary embodiments of the present invention.

FIGS. 1A-1F form a sequence of perspective diagrams that depict the operation of a first embodiment of a vehicle rollover simulation system 10 incorporating teachings of the present invention. System 10 replicates conditions in a vehicle enclosure during a rollover by manipulating a test article 12 that models the vehicle. Test article 12 has a floor 14 upon which to rest, a top surface 16, a center of gravity C₁₂ located intermediate floor 14 and top surface 16, and a test axis A₁₂ that corresponds to the longitudinal axis of the vehicle being modeled and that passes through center of gravity C₁₂.

In FIG. 1A, system 10 is depicted in a stationary starting condition thereof as including a test platform 20 having a leading edge 22, a trailing edge 24, and a horizontal carrying surface 26 extending therebetween. Secured to test platform 20 along trailing edge 24 thereof is an upstanding elongated trip block 28 that projects above carrying surface 26 to a height H₂₈. Floor 14 of test article 12 is upheld in an otherwise unsecured manner on carrying surface 26 with test axis A₁₂ thereof oriented generally parallel to the longitudinal extent of trip block 28. Under the influence of an appropriate propulsion source not included in FIGS. 1A-1F, test platform 20 with test article 12 carried thereon is capable of engaging in motion in a substantially horizontal test-initiation direction T_{I} that is normal to test axis A₁₂ of test article 12. As defined relative to test-initiation direction T_{I}, test article 12 has a leading face 30 and a trailing face 32.

By way of overview, when test platform 20 is driven in test-initiation direction T_{I}, the interaction between trip block 28 on test platform 20 with test article 12 imparts to test article 12 rotational motion about a tipping axis that is parallel to test axis A₁₂. The rotational motion of test article 12 inclines floor 14 thereof upwardly from carrying surface 26 of test platform 14 in a rollover direction R that is oppositely directed from test-initiation direction T_{I}. Eventually, test article 12 is ejected from test platform 20 in rollover direction R.

Stages of the motion of test platform 14 in test-initiation direction T_{I}, and the effects of that motion on test article 12, are depicted in FIGS. 1B-1F.

In FIG. 1B this process commences with the initiation of a driven motion M₂₀ of test platform 20 in test-initiation direction T_{I}. According to one aspect of the present invention, the driving pattern imposed on test platform 20 is complexly programmable in a manner that can be varied to simulate differing conditions of motion in test platform 20. Accordingly, the driving pattern imposed on test platform 20 is accurately reproducible.

As depicted in FIG. 1C, the motion commenced in FIG. 1B leads to motion of test article 12 relative to test platform 20. Trip block 28 bears against trailing face 32 of test article 12, urging floor 14 of test article 12 in test-initiation direction T_{I}. Center of gravity C₁₂ of test article 12 is, however, distanced higher above carrying surface 26 of test platform 20 than is the top of trip block 28. When test platform 20 is driven in test-initiation direction T_{I}, the stationary inertia of test article 12, which is in effect entirely concentrated at center of gravity C₁₂, tends to cause the top of test article 12 to move in rollover direction R relative to test platform 20. As a result, when test platform 20 engages in driven motion M₂₀, the interaction of trip block 28 and trailing face 32 of test article 12 imparts to test article 12 a rotational motion R₁₂ about a tipping axis A_{T} that passes through a tipping point P_{T} on test article 12 in close proximity to the top of trip block 28. When viewed from the vantage of support platform 20, the force exerted by trip block 28 against trailing face 32 of test article 12 well below center of gravity C₁₂ produces rotational motion R₁₂ in test article 12.

Floor 14 of test article 12 is shown in FIGS. 1A and 1B to be fully engaging of carrying surface 26 of test platform 20. As a result of rotational motion R₁₂, however, floor 14 begins to incline upwardly from carrying surface 26 at leading side 30 of test article 12. Test article 12 begins to tilt in rollover direction R, while test platform 20 continues in driven motion M₂₀. Tipping axis A_{T} for rotational motion R₁₂ is oriented generally parallel to test axis A₁₂ of test article 12. In FIG. 1C, test article 12 is commencing a simulated trip rollover relative to test platform 20.

The rollover of test article 12 progresses in FIG. 1D. Rotational motion R₁₂ of test article 12 brings leading face 30 of test article 12 into view and causes trailing face 32 thereof to pass out of sight. Center of gravity C₁₂ of test article 12 rises increasingly higher above carrying surface 26. Eventually, center of gravity C₁₂ passes over tipping point P_{T} in rollover direction R. Test platform 20 continues in driven motion M₂₀.

In FIG. 1E, interactions between test article 12 and test platform 20 or trip block 28 cease. Rotational motion R₁₂ of test article 12 carries test article 12 free of both, as trailing face 32 of test article 12 passes in rollover direction R at a clearance distance D_{C} above trip block 28. Test article 12 becomes a rotating projectile engaging in free fall motion in rollover direction R.

Ultimately, as shown in FIG. 1F, rotational motion R₁₂ and the free fall of test article 12 cause test article 12 to impact upon a receiving surface 36 that is distanced from test platform 20 in rollover direction R. The impact occurs on trailing face 32 or on top surface 16 of test article 12, simulating the impact phase of a trip rollover. According to the intensity of the vehicle rollover being simulated, test article 12 may, under the influence any of rotational motion R₁₂ not absorbed in that impact, continue to roll along receiving surface 36 in rollover direction R. When the duration interest for the rollover event being simulated is completed, driven motion M₂₀ of test platform 20 is no longer required and may begin to be terminated.

According to another aspect of the present invention, height H₂₈ of trip block 28 is adjustable to whatever degree is necessary to enable system 10 to simulate with test article 12 any desired type of trip rollover condition in the vehicle being modeled by test article 12. Thus, for example, the setting of trip block 28 at a relatively small height H₂₈ might be intended to simulate a trip rollover caused in the vehicle being modeled by test article 12 in a so-called “soil trip”, when the tires of the vehicle effect purchase on an unyielding surface, such as concrete, or even on a more pliant surface, such as asphalt, gravel, or soil. On the other hand, the setting of trip block 28 at a relatively large height H₂₈ might be intended to simulate a trip rollover caused in the vehicle being modeled by test article 12 in a so-called “curb trip”, when the tires of the vehicle encounter a curb or other roadside structure.

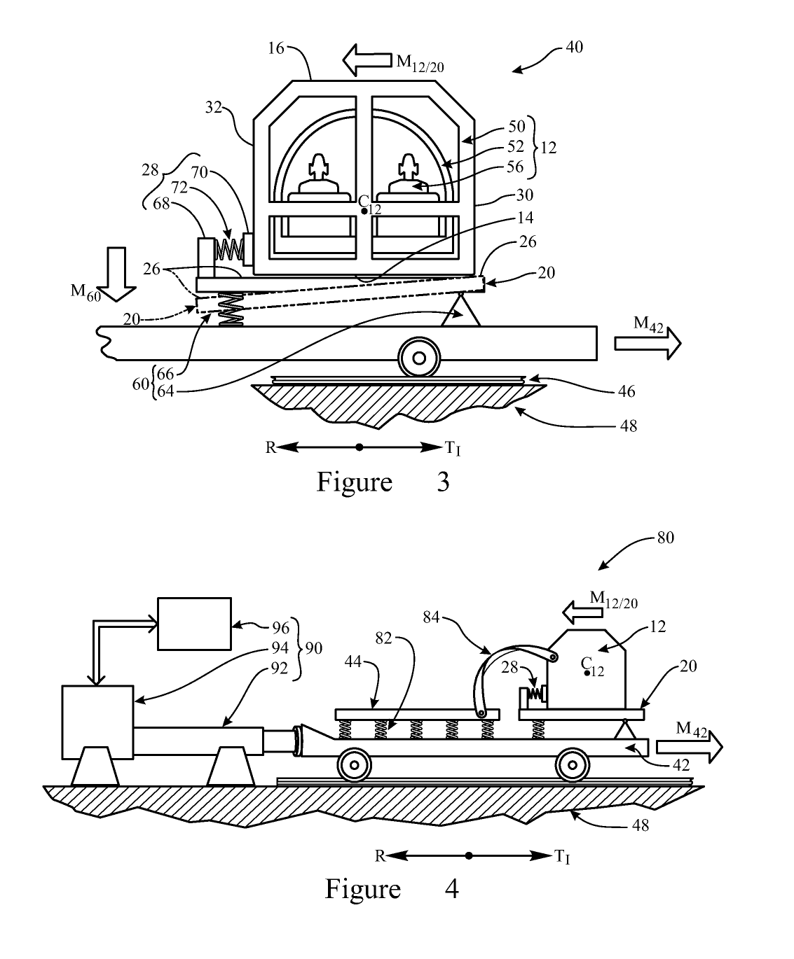

FIGS. 2A-2C form a sequence of diagrams depicting the operation of a second embodiment of a vehicle rollover simulation system 40 incorporating teachings of the present invention. System 40 replicates conditions in a vehicle enclosure during a rollover by manipulating test article 12 discussed above relative to FIGS. 1A-1F, and accordingly the same reference characters used earlier in the discussion of test article 12 will be employed as needed to identify selected aspects of test article 12 in FIGS. 2A-2C.

In FIG. 2A, system 40 is depicted in a stationary starting condition thereof as including test platform 20 with trip block 28 fixed thereto. Test platform 20 was discussed above relative to FIGS. 1A-1F, and accordingly, the same reference characters as were used earlier in the discussion of test platform 20 will be employed as needed to identify selected aspects of test platform 20 in FIGS. 2A-2C. Test article 12 is carried on test platform 20 in a manner not fixed thereto. Platform 20 is in turn borne on a carriage 42 that is moveable from a stationary position in substantially horizontal test-initiation direction T_{I} under the influence of an appropriate propulsion source that is not included in FIGS. 2A-2C. Also borne on carriage 42 at a position located in rollover direction R from test platform 20 is a landing platform 44.

Stages of the motion of carriage 42, and correspondingly of test platform 20 and landing platform 44, in test-initiation direction T_{I} and the effects of that motion on test article 12 are depicted in FIGS. 2B-2C. The motion of test article 12 in each of FIGS. 2B-2C is suggested by the depiction of test article 12 at an initial instant in phantom line and at a subsequent time in solid line. Thus, the position and the orientation of the phantom-line version of test article 12 precedes in time the position and the orientation of the solid-line version of test article 12 in each of FIGS. 2B-2C.

By way of overview, when carriage 42 is driven in test-initiation direction T_{I}, the interaction between trip block 28 on test platform 20 and test article 12 imparts rotational motion to test article 12 that inclines test article 12 upwardly from test platform 20 in rollover direction R. Eventually, test article 12 is ejected in rollover direction R from test platform 20. Landing platform 44 is configured to receive test article 12, when this occurs.

In FIG. 2B this process commences with the initiation of driven motion M₄₂ of carriage 42 and test platform 20 in test-initiation direction T_{I}. According to one aspect of the present invention, the driving pattern imposed on carriage 42 for this purpose is complexly programmable in a manner that can be varied to simulate differing conditions of motion in carriage 42. Accordingly, the driving pattern imposed on carriage 42 is accurately reproducible.

Trip block 28 bears against the phantom-line version of test article 12, and motion of test article 12 relative to test platform 20 commences. As depicted in solid line in FIG. 2B, test article 12 engages in rotational motion R₁₂. As a result of rotational motion R₁₂, the solid-line version of test article 12 begins to incline upwardly from test platform 20 in rollover direction R. Test article 12 tilts in rollover direction R, while carriage 42 and test platform 20 continue in driven motion M₄₂. In FIG. 2B, the solid-line version of test article 12 is commencing a simulated trip rollover relative to test platform 20.

In FIG. 2C, interactions between test article 12 and test platform 20 or trip block 28 cease. As shown in phantom, rotational motion R₁₂ of test article 12 carries test article 12 free of test platform 20 and trip block 28, and test article 12 passes in rollover direction R at a clearance distance D_{C} above trip block 28. The phantom-line version of test article 14 is a rotating projectile engaging in free fall motion in rollover direction R.

Ultimately, rotational motion R₁₂ causes the solid-line version of test article 12 to impact upon landing platform 44. The impact occurs on a face or on the top of test article 12, simulating the impact phase of a trip rollover. According to the intensity of the vehicle rollover being simulated, test article 12 may, under the influence any of rotational motion R₁₂ not absorbed in that impact, continue to roll along landing platform 44 in rollover direction R. When the duration interest for the rollover event being simulated is completed, driven motion M₄₂ of carriage 42 is no longer required and may begin to be terminated.

FIG. 3 is an elevation view of embodiments of selected elements of vehicle rollover simulation system 40 of FIGS. 2A-2C. Accordingly, system 40 includes as before test article 12 supported in an unsecured manner on test platform 20, trip block 28, and carriage 42. Carriage 42 is rollingly disposed on a rail 46 secured to a fixed surface 48, such as the ground or the floor of a test laboratory. Therefore, carriage 42 is capable of engaging in driven motion M₄₂ in test-initiation direction T_{I}. In response, test article 12 at least initially engages in relative motion M_{12/20} in rollover direction R, but will, as a result, eventually be ejected entirely from test platform 20 by interacting with trip block 28.

Test article 12 can be seen to include a rigid testing shell 50 that, by being sufficiently reinforced, is capable of nondestructively enduring successive rollover simulations by system 40. Housed within testing shell 50 in a removable manner is a model 52 of the enclosure of a vehicle with crash test dummies 56 seated therein. Differing models of vehicle enclosures can be installed temporarily within testing shell 50 to be studied in rollover conditions. Alternatively, the a rigid testing shell, such as testing shell 50, may be replaced with a design able to reproducibly simulate roof deformation in a vehicle being modeled.

Test platform 20 is borne on carriage 42 in such a manner that the horizontal orientation of carrying surface 26 with test article 12 upheld thereon varies in response to the initiation of driven motion M₄₂ by carriage 42. Toward that end, system 40 includes a dynamic mounting 60 on carriage 42 for test platform 20. Dynamic mounting 60 includes a pivotable support 64 for test platform 20 at a position on test platform 20 that is located in test-initiation direction T_{I} relative to testing shell 50, and a resilient support 66 for test platform 20 at a position on test platform 20 located in rollover direction R relative to testing shell 50. The initiation of driven motion M₄₂ by carriage 42 causes test platform 20 with the test article 12 upheld thereon to compress resilient support 66 and tilt downwardly in rollover direction R from pivotable support 64 as suggested by arrow M₆₀. The resulting inclination of carrying surface 26 at resilient support 66 is shown in phantom in FIG. 3. This behavior of dynamic mounting 60 simulates the vertical action of a vehicle suspension system as the vehicle engages in a lateral motion that might typically precede a rollover.

According to yet an additional aspect of the present invention, mounted on test platform 20 is an embodiment of trip block 28 that enables the simulation of the horizontal action of a vehicle suspension system as the vehicle engages in a lateral motion that might typically precede a rollover. Toward this end, trip block 28 is shown in FIG. 3 to include an upright 68 secured to carrying surface 26 of test platform 20 at a position located in rollover direction R from test article 12 upheld thereon. A test article engagement shoe 70 mechanically associated with upright 68 is abutted against test article 12 between floor 14 and center of gravity C₁₂ thereof. A substantially horizontally disposed resilient buffer 72 urges engagement shoe 70 away from upright 68 toward test article 12 in test-initiation direction T_{I}. As depicted in FIG. 3, by way of example, resilient buffer 72 takes the from of a compression spring, but a resilient buffer, such as resilient buffer 72, may with equal efficacy be possessed of pneumatic or other properties that allow but resist compression.

As test article 12 in FIG. 3 rests on, but is not otherwise attached to carrying surface 26, driven motion M₄₂ of carriage 42 and test platform 20 is not fully transferred to test article 12. Instead, the stationary inertia of test article 12 in the starting condition of system 40 causes test article 12 to slide along carrying surface 26 of test platform 20 toward trailing edge 24 thereof. As seen from the vantage of test platform 20, once carriage 42 and test platform 20 commences driven motion M₄₂, test article 12 engages in an oppositely-directed relative motion M_{12/20} in rollover direction R. Relative motion M_{12/20} of test article 12 in FIG. 3 is not, however, motion relative to the stationary condition of system 40.

Relative motion M_{12/20} of test article 12 causes test article 12 to travel along carrying surface 26, closing the distance between test article 12 and upright 68 of trip block 28. Trailing face 32 of test article 12, urges engagement shoe 70 of trip block 28 in rollover direction R, compressing resilient buffer 72 of trip block 28. When viewed from the vantage of test platform 20, resilient buffer 72 of trip block 28 is compressed by the urging of upright 68 toward trailing face 32 of test article 12. The performance characteristics of resilient buffer 72 are variably adjustable, thereby to model the horizontal action of a vehicle suspension system as the vehicle engages in a lateral motion that might typically precede a rollover.

FIG. 4 is an elevation view of a third embodiment of a vehicle rollover simulation system 80 incorporating teachings of the present invention.

System 80 includes from previously disclosed inventive systems test article 12 supported in an unsecured manner on test platform 20, a compressible embodiment of trip block 28, landing platform 44, and carriage 42. Carriage 42 is rollingly disposed on rail 46 for engaging in driven motion M₄₂ in test-initiation direction T_{I}. In response, test article 12 at least initially engages in relative motion M_{12/20} in rollover direction R, but will, as a result, eventually be ejected entirely from test platform 20 onto landing platform 44 due to interactions with trip block 28.

Landing platform 44 is provided with a resilient mounting 82 on carriage 42, thereby to be able to simulate various types of impact conditions encountered in a vehicle during the course of a rollover. A tether 84 flexibly secures test article 12 to landing platform 44, not only while test article 12 is carried on test platform 20, but following rollover simulation by system 80 as test article 12 impacts landing platform 44 and possibly continues to roll across the surface thereof. The construction of tether 84 is varied to suit the conditions of rollover being simulated by system 80. In FIG. 4, tether 84 takes the exemplary form of flexible webbing material connected between test article 12 and test platform 20. Alternatively, a tether, such as tether 84, takes the form of a cord or a sequence of pivotably end-to-end secured rigid links connected between landing platform 44 and test article 12 on test platform 20.

A propulsion source 90 operably interacts with carriage 42 to impart driven motion M₄₂ therethrough to test platform 20 and test article 12 upheld thereon. The driving pattern imposed on carriage 42 and test platform 20 by propulsion source 90 is accurately repeatable and programmable. Toward that end, propulsion source 90 includes a precision thruster 92 mounted to fixed surface 48. Precise control of thruster 92 is attained, by way of example, from a pulse generator 94 used in combination with a closed-loop servo-controller 96.

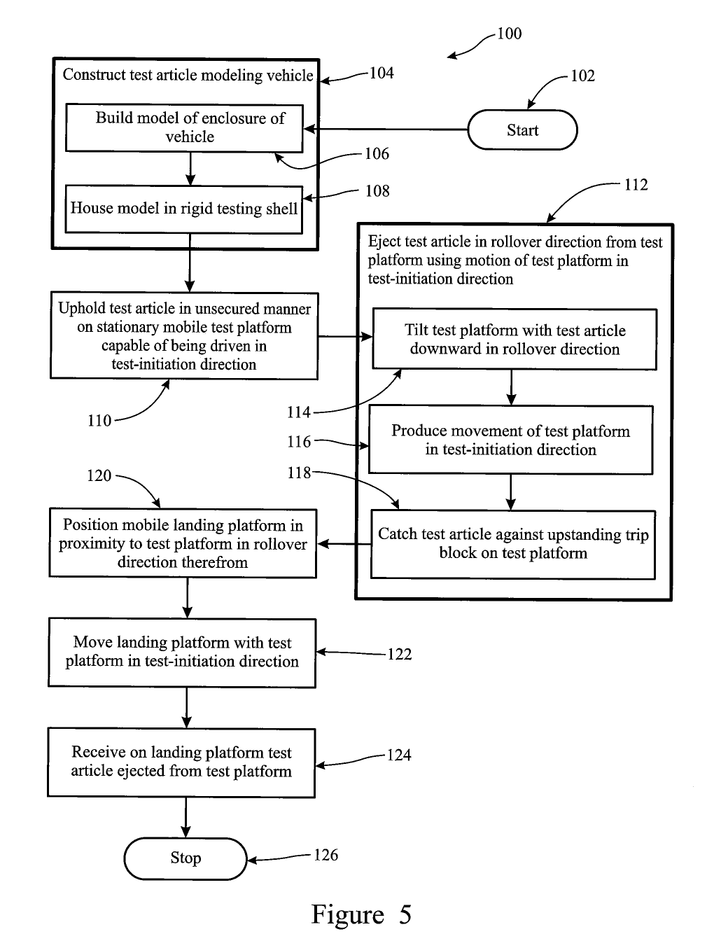

The present invention in addition contemplates methodology for simulating conditions in a vehicle enclosure during a tipped rollover. One exemplary embodiment of such as method 100 is presented in flow chart format in FIG. 5.

Commencing at an initiation oval 102, method 100 includes the step shown in a subroutine box 104 of constructing a test article modeling the vehicle for which rollover conditions are to be simulated. The test article has a floor, a center of gravity above the floor, and a test axis corresponding to the longitudinal axis of the vehicle being modeled. The construction of such a test article involves the step set forth in an instruction rectangle 106 of building a model of the passenger enclosure of the vehicle, and the step set forth in an instruction rectangle 108 of housing that model in a rigid testing shell.

In an instruction rectangle 110, method 100 continues with the step of upholding the floor of the test article in an unsecured manner on a mobile test platform that is configured for motion in a substantially horizontal test-initiation direction normal to the test axis of the test article on the test platform.

Then method 100 undertakes the step shown in a subroutine box 112 of ejecting the test article from the test platform in a rollover direction that is opposed to the test-initiation direction using motion of the test platform in the test-initiation direction to do so. This is accomplished by the step set forth in an instruction rectangle 114 of tilting the test platform with the test article thereon downwardly in the rollover direction, the step set forth in an instruction rectangle 116 of producing movement of the test platform in the test-initiation direction, and the step set forth in an instruction rectangle 118 of catching the test article between the floor and the center of gravity thereof against an upstanding trip block on the test platform.

Also involved in method 100 are the step set forth in an instruction rectangle 120 of positioning a mobile landing platform in proximity to the test platform in the rollover direction therefrom, the step set forth in an instruction rectangle 122 of moving the landing platform with the test platform in the test-initiation direction, and the step set forth in an instruction rectangle 124 of receiving the test article ejected from the test platform on the landing platform. Method 100 concludes in a termination oval 126.

Selected features of the inventive technology and various benefits afforded thereby will be highlighted below.

The inventive system is designed to utilize existing sled test facilities that are equipped with servo-control pulse generation sled systems. The servo-control feature provides both pulse accuracy at accelerations below approximately 10 g-forces, and reliability of performance, notwithstanding a changing effective payload mass caused by the test article not being rigidly fixed to elements of the system.

The test article used is smaller in size than a full vehicle. This reduces both the weight of the equipment required to conduct rollover simulations and the amount of laboratory space needed to do so. Portions of the vehicle that are not critical to the environment being tested are eliminated in the test article, which is itself reinforced to maintain dimensional stability and to minimize the extent of structural deformations. The reinforced test article provides a dimensionally accurate representation of relevant vehicle features, including mountings for interior components, such as trim, seats, steering controls, instrument panels, and occupant restraints. Reproduced in the test article is the height of the center of gravity of the vehicle being modeled, as well as a trip point lower than that center of gravity that corresponds to the exterior location on the tires of the vehicle being modeled at which those tires are considered to meet a predetermined type of tripping obstacle in a rollover.

The test article rests on a pivotable support plane that takes the form of a test platform secured by a hinge at one side thereof to a carriage of the sled system. The end of the support plane opposite from the hinge is supported on the carriage by a spring. The properties of the spring can be adjusted to vary the levelness of the test article, or to control the extent to which the test article dips in modeling the roll of a vehicle from suspension system compression in the face of the lateral deceleration that is not uncommon just prior to a tripped rollover.

The hinged support plane carries a trip block that transfers motion of the carriage laterally to the trip point on the test article. A compressible trip block simulates the lateral motion of a vehicle relative to the tires thereof when lateral compression occurs in the suspension system of the vehicle being modeled. It is the application of lateral acceleration to the test article trip point that generates conditions that cause the test article to roll. The height of the trip block is adjustable so as to correspond functionally to various trip heights on a vehicle that arise in different trip conditions. For example, tripping on concrete entails a relatively low trip height, tripping in gravel or soil entails a medium trip height, and tripping against a curb entail a higher trip height.

The landing platform is also mounted to the carriage and is cushioned to allow the reinforced test article to impact the surface of the landing platform in a manner that simulates the impact accelerations experienced by a full vehicle body. In a full vehicle rollover, impact acceleration is affected by the deformation of the roof structure of the vehicle enclosure and by the deformation of the landing surface, particularly if the landing surface is a soft soil. In the inventive system, the structure of the test article corresponding to the roof of the vehicle being modeled will normally be reinforced. Therefore, in that system, the control of impact acceleration is managed completely through the cushioned landing platform.

The inventive technology achieves good test-to-test repeatability by controlling significant variables. Input acceleration in a full vehicle test is subject to variability due to the type of skid surface employed, such as concrete, pavement, or soil as opposed to sand, as well as due to skid surface conditions, such as moisture content and compaction. In the present invention, the control of vehicle acceleration inputs is achieved accurately and repeatably using a closed loop servo-controlled pulse generator. Being thusly controlled, the input pulse for the inventive system can be more complex, more accurate, and more repeatable than are the deceleration pulses that are generated in a crash test laboratory.

Each full vehicle rollover crash simulation involves not only the direct costs of testing, but also the expenditure of a test vehicle, which during development stages can be many times the cost of an actual production vehicle. A typical full vehicle rollover crash simulation ranges in cost from about $12,000 to about $25,000. The inventive technology utilizes a reinforced section of the vehicle compartment, or a fabricated simulation of the vehicle compartment, instead of a full vehicle. The same test article can be used for many tests, with only necessary interior vehicle components and occupant restraints being replaced. Using the inventive method, the cost of a single test can be expected to drop to between about $4,000 and $6,000.

A single rollover crash test may require up to 40 man-hours of vehicle preparation, plus several hours in the crash laboratory preparing the test facility and completing and verifying the test setup. By not utilizing a crash barrier, the inventive technology enables rollover simulations to occur in test sled laboratories, environments in routine use in the development of vehicle occupant restraint systems for impact crashes. Many restraint systems suppliers have sled test facilities, but few have ready access to crash test facilities. Where crash test laboratories do exist, those facilities are normally fully engaged in conducting full scale barrier crash tests.

Crash test dummy positioning in an inventive system is highly controllable, as no significant movement arises in the test article in advance of the actual initiation of a rollover. Most other rollover simulation methods require the towing of a carriage of a sled system to a substantial speed before an actual rollover event is initiated. This motion on the test track can upset the position of a crash test dummy before the simulated rollover actually commences, adding uncertainty to the acquired test results.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed is:

1. A system for simulating conditions in a vehicle enclosure during a tripped rollover through the manipulation a test article modeling the vehicle, the test article having a floor upon which to rest, a center of gravity above that floor, and a test axis that corresponds to the longitudinal axis of the vehicle being modeled, the system comprising:
(a) a movable test platform having a horizontal carrying surface capable of upholding the floor of the test article in a manner unsecured to the test platform; and
(b) a propulsion source operably interacting with the test platform and capable of driving the test platform with the test article upheld thereon in a substantially horizontal test-initiation direction normal to the test axis of the test article, interaction between the driven test platform and the test article imparting to the test article rotational motion about a tipping axis oriented parallel to the test axis, the rotational motion of the test article inclining the floor of the test article upwardly from the carrying surface of the test platform in a rollover direction opposed to the test-initiation direction and ejecting the test article from the test platform in the rollover direction.

2. A system as recited in claim 1, wherein a driving pattern imposed on the test platform by the propulsion source is accurately repeatable and programmable.

3. A system as recited in claim 2, wherein the propulsion source comprises a servo-controlled thruster.

4. A system as recited in claim 1, further comprising a trip block upstanding from the carrying surface of the test platform at a position located in the rollover direction from the test article upheld thereon, motion of the test platform in the test-initiation direction causing the trip block to bear against the test article between the floor and the center of gravity thereof.

5. A system as recited in claim 4, wherein the trip block is resiliently compressible in the rollover direction against the test article.

6. A system as recited in claim 5, wherein the amount of the force borne against the test article by the trip block corresponds to the degree of the compression of the trip block.

7. A system as recited in claim 5, wherein the trip block comprises:
(a) an upright secured to the carrying surface of the test platform at a position located in the rollover direction from the test article upheld thereon;
(b) a test article engagement shoe capable of abutting the test article between the floor and the center of gravity thereof; and
(c) a substantially horizontally disposed resilient buffer urging the engagement shoe away from the upright in the test-initiation direction.

8. A system as recited in claim 4, wherein the height of the trip block above the carrying surface of the test platform is selectively adjustable.

9. A system as recited in claim 1, wherein the horizontal orientation of the carrying surface of the test platform with the test article upheld thereon varies in response to the initiation of a driving pattern imposed on the test platform by the propulsion source.

10. A system as recited in claim 9, wherein the initiation the driving pattern causes the carrying surface of the test platform with the test article upheld thereon to tilt downwardly in the rollover direction.

11. A system for simulating conditions in the enclosure of a vehicle during a tripped rollover, the system comprising:
(a) a carriage moveable from a stationary position in a substantially horizontal test-initiation direction;
(b) a test platform having a horizontal carrying surface, the test platform being dynamically borne on the carriage, thereby enabling the horizontal orientation of the carrying surface of the test platform to vary in response to initiation of movement of the carriage;
(c) a rigid testing shell housing a model of the enclosure of the vehicle, the testing shell with the model housed therein having a floor, a center of gravity above the floor, and a test axis corresponding to the longitudinal axis of the vehicle being modeled, the testing shell being upheld by the floor thereof on the carrying surface of the test platform in a manner unsecured to the test platform with test axis of the testing shell oriented normal to the test-initiation direction; and
(d) a trip block upstanding from the carrying surface of the test platform at a position located relative to the testing shell upheld thereon in a rollover direction opposed to the test-initiation direction, motion of the test platform in the test-initiation direction causing the trip block to bear against the testing shell between the floor and the center of gravity thereof.

12. A system as recited in claim 11, further comprising a rail, the carriage being rollingly disposed thereon.

13. A system as recited in claim 11, further comprising a mounting on the carriage for the test platform, the mounting comprising:
(a) a pivotable support for the test platform at a position on the test platform located in the test-initiation direction relative to the testing shell on the test platform; and
(b) a resilient support for the test platform at a position on the test platform located in the rollover direction relative to the testing shell on the test platform.

14. A system as recited in claim 11, wherein the height of the trip block above the carrying surface of the test platform is selectively adjustable.

15. A system as recited in claim 11, further comprising a landing platform borne on the carriage at a position located in the rollover direction from the test platform, the landing platform being configured to receive the testing shell when motion of the carriage in the test-initiation direction ejects the testing shell from the test platform.

16. A system as recited in claim 15, further comprising a resilient mounting on the carriage for the landing platform.

17. A system as recited in claim 15, further comprising a tether flexibly securing the testing shell on the test platform to the landing platform.

18. A system as recited in claim 17, wherein the tether comprises flexible webbing connected between the landing platform and the testing shell on the test platform.

19. A system as recited in claim 11, further comprising an accurately repeatable programmable servo-controlled thruster operably intractable with the carriage to drive the carriage, the test platform, and a test shell in the test-initiation direction.

20. A system as recited in claim 11, wherein:
(a) the trip block is resiliently compressible in the rollover direction against the test article, and
(b) the amount of the force borne against the test article by the trip block corresponds to the degree of the compression of the trip block.

21. A method for simulating conditions in a vehicle enclosure during a tipped rollover, the method comprising the steps of:
(a) constructing a test article modeling the vehicle, the test article having a floor, a center of gravity above the floor, and a test axis corresponding to the longitudinal axis of the vehicle being modeled;
(b) upholding the floor of the test article in an unsecured manner on a mobile test platform configured for motion in a substantially horizontal test-initiation direction normal to the test axis of the test article thereon; and
(c) ejecting the test article from the test platform in a rollover direction opposed to the test-initiation direction using motion of the test platform in the test-initiation direction.

22. A method as recited in claim 21, further comprising the steps of:
(a) positioning a mobile landing platform in proximity to the test platform in the rollover direction therefrom;
(b) moving the landing platform with the test platform in the test-initiation direction; and
(c) receiving the test article ejected from the test platform in the rollover direction.

23. A method as recited in claim 21, wherein the step of ejecting comprises the step of causing the trip block to bear against the test article between the floor and the center of gravity thereof.

24. A method as recited in claim 23, wherein the step of ejecting further comprises the step of tilting the test platform with the test article thereon downwardly in the rollover direction.

25. A method as recited in claim 21, wherein the step of ejecting comprises the steps of:
(a) producing movement of the test platform in the test-initiation direction relative to the test article upheld thereupon; and
(b) catching the test article between the floor and the center of gravity thereof against an upstanding trip block on the test platform, the trip block being compressible in the rollover direction by the movement of test platform in the test-initiation direction relative to the test article.
